(19) United States
(12) Patent Application Publication
(10) Pub. No.: US 2003/0097402 A1
(43) Pub. Date: May 22, 2003

(54) System and method for electronically interchanging values

(76) Inventor: Per Vindeby, Munchen (DE)

Correspondence Address: Kevin R. Spivak, Morrison & Foerster LLP, Suite 300, 1650 Tysons Boulevard, McLean, VA, 22102, US

(21) Appl. No.: 10/259,829

(22) Filed: Sep. 30, 2002

(30) Foreign Application Priority Data
Oct. 1, 2001 (DE) 10148468.2

(51) Int. Cl. G06F 15/16

(52) U.S. Cl. 709/203

(57) ABSTRACT

A system and method where a value sender's values are managed on central servers. On the central server, a separate value credit line for offline transfers is managed in a value account associated with the sender by virtue of the corresponding value credit optionally being reserved for the credit line in the sender account. During an online connection, the value credit still available which is stored on an intelligent device and also the values demanded by the receiver are communicated to the server. The value sender's value account on the server is reduced by the value sum used. During an online connection, the server transmits the arranged credit line to the read/write unit. A transmitted credit line is stored on the intelligent device as available value credit. For offline transactions, the available value credit on the device is reduced by the values transmitted to the receiver.

### CLAIM FOR PRIORITY

This application claims priority to Application No. 10148468.2 which was filed in the German language on Oct. 1, 2001.

### TECHNICAL FIELD OF THE INVENTION

The invention relates to a system and method for electronically interchanging values in a communication network.

### BACKGROUND OF THE INVENTION

Electronic systems for transmitting values have been in use for a relatively long time and are becoming more and more popular. In this case, values are generally transmitted as a reciprocal payment for the receipt of services and goods. With previous electronic methods, the values are either on a carrier medium belonging to the user (e.g. on a chip card, as in the case of cash cards) or on central servers (best known examples are EC cards and credit cards).

Values on a Carrier Medium

This method permits rapid transmission of values from a sender to a receiver without the need for the receiver system to be linked online to a central server. However, if the carrier medium falls into the hands of another person (e.g. as a result of theft), these values can also be misused by the person. For this reason, the maximum available cash value on cash cards—which are used as a substitute for cash—is generally limited in the case of this system.

Another drawback of this system is that the values can be accessed only using the respective carrier medium. Other use, such as transmission of the values as reciprocal payment for the use of particular services on a mobile phone, cannot be direct-debited from this value credit, or can be direct-debited only in a very complex manner.

To do this, the user requires, for example when he is out and about, an appropriate read/write unit (for the carrier medium) with a suitable network connection to the receiver's system.

Values on Central Servers

In the case of server-based electronic systems for transmitting values, the values are stored on central servers. If a user wishes to use such a system to transmit values for the use of goods or services, then it is generally first necessary to check whether his value account, on the central servers, contains sufficient values.

However, this requires an online data link between the sales point (front end) for the value receiver (e.g. cash register system or vending machine) and the value account on the server. In many scenarios, particularly with very small values (e.g. micropayment), an online mode is not economical and effective, however:

the necessary network access needs to be provided

transfer charges are incurred; and

there is a time delay for the check with the server

The server-based method affords a relatively high level of security (no loss of values if the carrier medium is lost), but requires an online data link from the front end to the server in order to transmit the values. One drawback is that value transmission becomes impossible as soon as the data link is interrupted, for example in the event of a fault.

To date, the problem has been solved by virtue of there being different methods for the respective requests, such as, in the case of payment transactions, the use of a cash card for small sums (micropayment) and EC/credit cards for larger sums (macropayment). From the point of view of the value receiver (trader) and the value sender (customer), this approach is not particularly appealing, however, since it often means additional effort/costs for the receiver, and the sender needs to assign his values to various methods. Even if there are already solutions which, by way of example, combine both a cash card and an EC card on one card, the methods are separate and the values are also stored separately.

WO 00/67177 discloses a method for electronically transferring values which works both in an online state and in the offline state. Transactions performed during an offline period are stored in a terminal and are transferred to the server in the next synchronization phase. A drawback this solution is that, for transactions performed during an offline state, there is no certainty that the total amount of the transaction is actually covered by the value credit.

### SUMMARY OF THE INVENTION

The invention discloses a server-based system and method which allows values to be transmitted in online mode and in an offline mode while avoiding the aforementioned drawbacks.

The system and method is based on a server-based approach, that is to say the value sender' values are managed on central servers.

On the server, in one embodiment, a separate value credit line for offline transfers is managed in a value account associated with the sender by virtue of the corresponding value credit optionally being reserved for the credit line in the sender account.

In one aspect of the invention, during the course of an online connection, the value credit still available which is stored on the intelligent device—e.g., a carrier medium in the form of, by way of example, a chip card, a transponder card or else a SIM card in the mobile phone and also the values demanded by the receiver are communicated to the server. The value sender's value account on the server is reduced by the value sum used (value credit line minus the value credit which is still available).

In one aspect of the invention, during the course of an online connection, the server transmits the arranged credit line to the read/write unit (which is with the trader, for example).

In another aspect of the invention, a transmitted credit line is stored on the intelligent device as available value credit. For offline transactions, the available value credit on the device is reduced by the values transmitted to the receiver.

In another aspect, the value sender (customer) has an intelligent device (carrier medium in the form of, by way of example, a chip card, a transponder card, a SIM card in the mobile phone) which he can use to identify himself and which can also be used to store these data. The value receiver (e.g. sales points for a trader in a shop or at a vending machine) has a suitable read/write unit which is able to read and to write to the user's intelligent device. The data can be transmitted in various ways, e.g. by retrieving information from the contacts on a chip card, or contactlessly via radio and infrared.

In yet another aspect, when the sales point sets up an online data link to the value sender's server for transmitting values, the values demanded are transferred to the value receiver from the value sender's value account. For this purpose, the value receiver likewise has a suitable value account.

In the course of an online connection to the server, in another aspect, the sender should authorize the transmission of values. This can be done using methods which are already known to the person skilled in the art, for example using a secret number (PIN) or using biometric methods (e.g. fingerprint).

In still another aspect, in order to permit values to be transmitted in offline mode two (i.e. there is no online data link to the value sender's server), a value credit line is stipulated on the intelligent device. The level of the credit line can be arranged between the value sender and the provider of the method.

In another aspect, if the sender wishes to transmit values but the process is being handled in offline mode, then the value credit line on the intelligent device is reduced by the transmitted values, and reception of the values is confirmed to the value receiver. In this case, the sender can transmit a maximum of as many values as permitted by the stored value credit line. Furthermore, a transaction history can also be stored on the intelligent device. The value transaction in the value receiver's account can then be transmitted in line with today's standard methods (e.g. submission of the electronic transaction documents at the end of every month).

In still another aspect, whether the value receiver uses an offline mode or an online mode can be a decision taken by the value receiver, with the operator of the value system being able to make particular stipulations. In principle, the offline mode is intended for transmitting very small values and for value transmissions which can be handled in a very short time, e.g. the payment process at a ticket machine in a great crush. On the other hand, the advantage of online transmission for the value receiver is that larger value sums are feasible and that, in principle, he receives his value credit immediately.

In still another aspect, when the sender effects a value transmission whose transmission involves the sales point setting up an online data link to the server, the values for the directly obtained goods or service are reduced directly on the server. Furthermore, it is also possible for the value credit used to be debited automatically from the account and for the credit line to be reset again on the intelligent device. The credit is also reset if the online transmission is made for a different value receiver than previous offline transactions. “Loading machines” provided specifically for this purpose can also exist. Advantageously, the value credit line can also be reset on or using an Internet PC with a connected read/write unit for the intelligent device.

In yet another aspect, for the granted value credit line on the sender's intelligent device, the provider of the value interchange system can, for his protection, reserve the appropriate value sum in the sender's account. This is particularly appropriate in the case of pure credit accounts (prepaid), since these generally cannot have any negative values. This ensures that the value credit used is always covered. Alternatively, in scenarios where the operator of a value interchange system pays interest on a credit in the account, the reserved values could be excluded from payment of interest (since the values could be used by the user, of course).

In another aspect, instead of a credit line, it is also possible for a value credit to be stored on the intelligent device. For value transmissions in online mode, the credit is then available to the sender: the credit in the account plus the unused credit line on the intelligent device.

In another aspect, the sales point can have a display facility which allows the sender to find out his available value credit. This functionality can also be implemented using other units, such as a PC having a suitable read/write unit.

The invention has many advantages for the sender, for example:

A sender can transparently handle micro-payments and macro-payments using just one intelligent device. The sender thus requires just one account and does not need to split his value credit for micro-payments and macro-payments (as today when using cash cards and EC cards in parallel).

Since a server-based system is involved, the account can also be accessed in other ways, and hence “off-site” transactions (i.e. not in situ) are permitted, such as are possible for value transmissions using a mobile phone or the Internet.

Small values can be transmitted and debited quickly, easily and economically, since no online connection to the server is required. The senders thus incur low costs, since the sales points do not need to have any online data link for transmitting the values—particularly very small sums. In addition, a high level of availability is thus achieved, since value transmissions are also possible in offline mode (if the online data link to the server fails)—up to the respective credit line on the intelligent device. The value receiver can be guaranteed of the transmission of values in both variations (online or offline), since debiting can be performed in real time and the values are reserved for the credit line on the intelligent device in the account as appropriate.

The credit line is automatically reset again as soon as the user transmits values in online mode. Special “loading machines” or else Internet methods on the PC can likewise be used.

To protect the operator of the value interchange system, the credit line can be reserved in the user's account.

Limited risk arises: if the intelligent device is lost, the sender loses no more than the credit line which is still available, and the intelligent device can be used only where no online connection is set up to the server (since otherwise the value transmission needs to be authorized). In addition, the credit line will generally be much lower than in the case of pure “offline” systems (e.g. the credit on a cash card), since larger values (macropayment) are generally routed directly via the server anyway.

Flexibility for the value receiver: the receiver decides (e.g. according to the level of the sum) whether he/she wishes to use online mode or offline mode.

The sender can be anonymous to the receiver.

The system supports both accounts which are intended to hold exclusively positive values (prepaid accounts) with real-time requests and conventional accounts.

### BRIEF DESCRIPTION OF THE DRAWINGS

The invention is explained below using exemplary embodiments. In this context,

FIG. 1 shows a flowchart for offline value transmission.

FIG. 2 shows a flowchart for online value transmission.

FIG. 3 shows the design of a system in accordance with the invention.

FIG. 4 shows a flowchart for a debit operation.

### DETAILED DESCRIPTION OF THE PREFERRED EMBODIMENTS

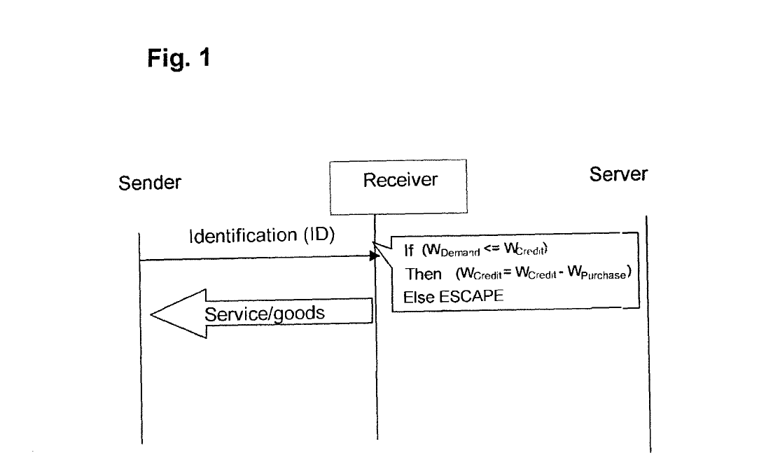

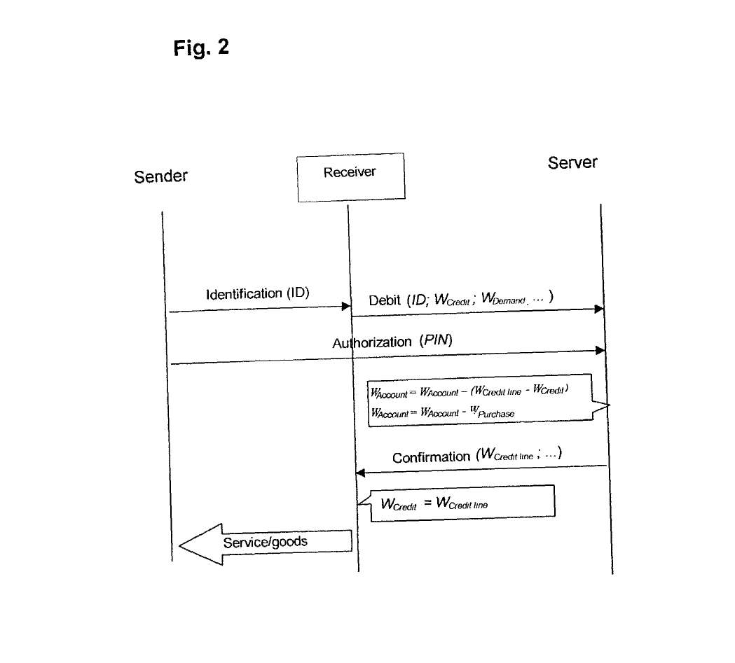

The figures show a possible sequence first without an online check with the server (FIG. 1), and with an online check (FIG. 2). The two transactions can take place with the same or different value receivers.

The user identifies himself for value transmission with his unique ID (identification), e.g. using his intelligent device. Since the value receiver does not set up a connection to the server in the first case, there is first a check to determine whether there is sufficient credit on the intelligent device (if (W_{Demand}<=W_{credit}) . . . ). If so, the credit is reduced by the demand (Then ($_{Demand}=$_{Credit}−$_{Demand})). Otherwise, the transaction is rejected. If successful, the desired service/goods is/are delivered.

For the next transaction, the value receiver sets up a connection to the server for debiting the values demanded by the receiver, FIG. 2. At the same time, the server is also notified of the credit on the intelligent device. Next, the sender authorizes the value transmission using a PIN. The sender's account on the server is reduced both by the credit used ($_{Credit line}−$_{Credit}) and by the values demanded. If the value credit in the account is sufficient, the server confirms the value transmission (Confirmation) and transfers the arranged credit line. In this case, a value sum at the level of the credit line can be reserved in the account. The credit on the intelligent device is set to the credit line again and the value receiver delivers the service/goods.

On the server, the value level (W_{Account}) and the arranged credit line (W_{Credit line}) are identified. The intelligent device stores not only the unique ID but also the value credit (W_{Credit}) which is still available. In addition, a transaction history can be stored for offline transmissions.

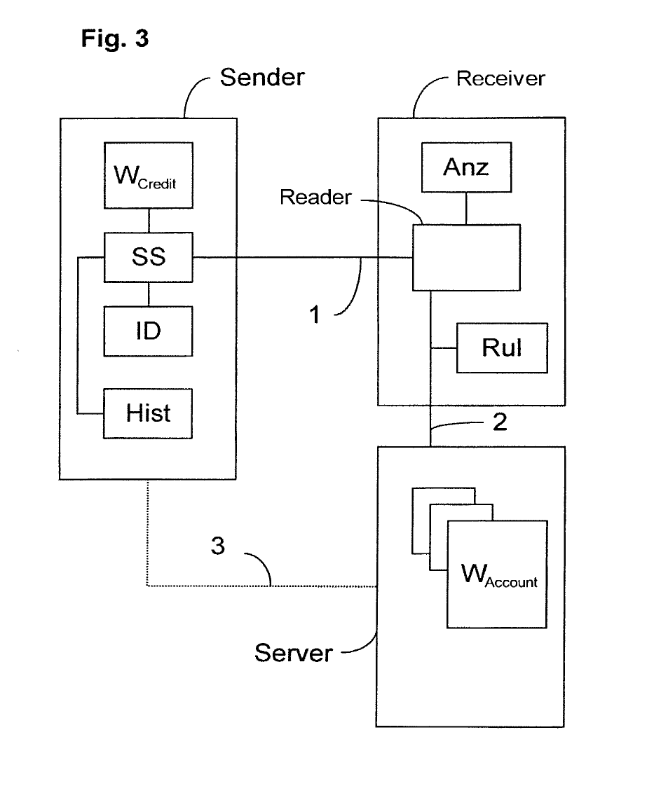

FIG. 3 shows the components in a system which interact when values are transmitted both online and offline. The sender has an identification device (e.g., ID, intelligent device) which stores his credit line (W_{Credit}) Optionally, transactions which have already been performed are saved in a memory (Hist). When the intelligent device has been read in a read/write device (reader), transaction data can now be transferred between the value receiver and the sender (1). In this case, the receiver can decide whether the transfer is to be made online or offline, and particular rules can be applied in this case (Rul). If an online transfer is to be made, then the sender sets up a connection to the server where the sender's value credit (W_{Account}) is managed (2). This connection can simultaneously be used to increase the credit line which the customer has further (3).

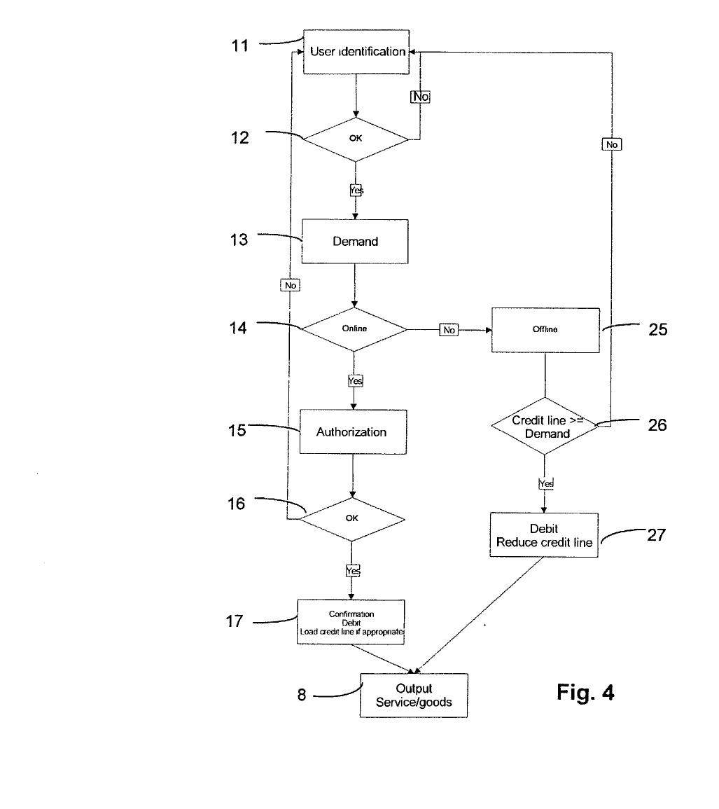

FIG. 4 shows a flowchart illustrating the transactions with the value receiver. Following successful user identification (11) and transfer of the credit which is to be transferred (13), the decision is made regarding whether an online transfer (14) or an offline transfer (25) is to be made. In the case of the online transmission, additional authorization is obtained. When the debit to the value account has been made, the credit line is possibly reloaded on the identification medium. In the case of an offline transmission, a check is first carried out to determine whether the credit line is sufficient to cover the values which are to be transferred, and the transfer is then made and the credit line is reduced. As a final step, the service/goods is/are released in both cases.

What is claimed is:

1. A method for electronically interchanging values from a server credit on a central server to a receiver credit, comprising:
blocking a credit portion of the server credit and making the credit portion available on an intelligent device for identifying the credit portion;
deducting a transferrable credit from the credit portion; and
reducing the server credit by the transferrable credit when a connection is set up to the central server.

2. The method as claimed in claim 1, wherein the intelligent device is a chip card, a transponder card, a SIM card or a portable storage medium.

3. The method as claimed in claim 1, wherein the deducting is performed a plurality of times before the reducing is performed.

4. The method as claimed in claim 1, wherein the connection setup in the reducing is coupled to the transfer of another transferrable credit to another receiver.

5. The method as claimed in claim 1, wherein the credit receiver decides whether the reducing is performed together with the deducting.

6. The method as claimed in claim 1, wherein a transfer operation includes indicating the size of the remaining credit portion.

7. The method as claimed in claim 1, further comprising increasing the credit portion on the intelligent device.

8. A method for electronically interchanging values from a server credit on a central server to a receiver credit, comprising:
providing a credit portion of the server credit and making the credit portion available on an intelligent device; and
deciding, the receiver having read the intelligent device, whether the receiver will perform the transfer in a debit operation or whether a connection will be set up to the central server and the transferrable credit will be transferred directly from the server credit.

9. The method as claimed in claim 8, wherein the decision is made based on a level of the transferrable credit.

10. A device for electronically interchanging values, comprising:
an identification device;
a storage device to store a credit portion which represents a portion of a server credit; and
a connection device to set up a connection to a read unit, which connection is configured for transferring a transferrable credit to a receiver credit.

11. The device as claimed in claim 8, wherein the storage device, or another storage device, stores information about transfer transactions which have already been carried out.

12. A device for receiving a transferrable credit, comprising:
a receiving device to receive a transferrable credit via a first connection;
a set-up device to set up a second connection to a central server; and
a storage device to store decision rules about whether the second connection is configured for receiving th transferrable credit.

13. The device as claimed in claim 10, further comprising a display device to display a level of remaining credit portion.
